(19) United States
(12) Patent Application Publication
(10) Pub. No.: US 2025/0037103 A1
(43) Pub. Date: Jan. 30, 2025

(54) MOBILE PAYMENT DEVICE CASE AND CHARGING SYSTEM

(71) Applicant: Havis, Inc., Warminster, PA (US)

(72) Inventor: Jamie W. Brandt, Faribault, MN (US)

(73) Assignee: Havis, Inc., Warminster, PA (US)

(21) Appl. No.: 18/776,379

(22) Filed: Jul. 18, 2024

Related U.S. Application Data
(60) Provisional application No. 63/529,427, filed on Jul. 28, 2023.

(51) Int. Cl. G06Q 20/20; B41J 15/04; B41J 29/13; G06F 1/16; G06Q 20/32

(52) U.S. Cl. CPC G06Q 20/209; B41J 15/042; B41J 29/13; G06F 1/1607; G06F 1/1632; G06Q 20/322

(57) ABSTRACT

A mobile device case and a mobile device charging system are disclosed. The mobile device case is provided for a mobile device having at least one compartment closed by a mobile device door pivotable on a mobile device hinge. The mobile device case includes a protective shell and a mobile device case door. The protective shell is configured to surround and protect at least a portion of the mobile device. The mobile device case door is coupled to the protective shell via a mobile device case hinge. The mobile device case door is pivotable on the mobile device case hinge between a closed position and an open position. When the mobile device is accommodated within the protective shell, the at least one compartment is accessible by way of the mobile device door and the mobile device case door.

### CROSS-REFERENCE TO RELATED APPLICATIONS

This application claims priority to U.S. Patent Application No. 63/529,427, entitled “MOBILE PAYMENT DEVICE CASE AND CHARGING SYSTEM,” filed Jul. 28, 2023, the contents of which are incorporated herein by reference in their entirety.

### TECHNICAL FIELD

The present invention relates generally to protective cases for mobile electronic devices, and more particularly, to protective cases and charging systems for mobile payment processing devices.

### BACKGROUND

Mobile electronic devices such as phones and tablets are a ubiquitous part of daily life, and an essential tool in many different professions. By their nature, many mobile electronic devices are particularly sensitive to physical damage, which may arise from inadvertent drops, falls, or collisions. As a result, protective cases and covers have been developed for mobile electronic devices that provide a measure physical protection while minimizing disruption to or loss of device functionality.

The usefulness of protective covers may be limited, however, by the physical features of the electronic device for which the cover is designed. For example, certain mobile electronic devices, such as mobile payment processing devices, may include features that can be inhibited, blocked, or disabled by portions of a protective cover. Likewise, protective covers may interfere with charging arrangements of certain mobile electronic devices, thereby requiring regular removal of the cover to enable charging or access to important functionality. There remains a need to provide improved protective covers for mobile devices addressing these issues.

### SUMMARY

Aspects of the present invention are directed to a mobile device case and mobile device charging system.

An example mobile device case is provided for a mobile device having at least one compartment closed by a mobile device door pivotable on a mobile device hinge. The mobile device case includes a protective shell and a mobile device case door. The protective shell is configured to surround and protect at least a portion of the mobile device. The mobile device case door is coupled to the protective shell via a mobile device case hinge. The mobile device case door is pivotable on the mobile device case hinge between a closed position and an open position. When the mobile device is accommodated within the protective shell, the at least one compartment is accessible by way of the mobile device door and the mobile device case door.

An example mobile device charging system includes a mobile device case and a mobile device charging cradle. The mobile device case has a protective shell configured to surround and protect at least a portion of a mobile device. The mobile device charging cradle has a cradle charging interface. The mobile device includes a device charging interface on a first surface thereof. The protective shell includes one or more apertures on a portion of the protective shell covering the first surface. The mobile device charging cradle includes one or more projections positioned to correspond to the one or more apertures. The one or more projections directly contact the first surface of the mobile device through the one or more apertures when the mobile device is in the mobile device case and the device charging interface is coupled to the cradle charging interface.

### BRIEF DESCRIPTION OF THE DRAWINGS

The invention may be best understood from the following detailed description when read in connection with the accompanying drawings, with like elements having the same reference numerals. When a plurality of similar elements are present, a single reference numeral may be assigned to the plurality of similar elements with a small letter designation referring to specific elements. When referring to the elements collectively or to a non-specific one or more of the elements, the small letter designation may be omitted. In addition, according to common practice, the various features of the drawings are not drawn to scale unless otherwise indicated, and the dimensions of the various features may be expanded or reduced for clarity. Included in the drawings are the following figures:

FIG. 1 shows a perspective view of an example of a mobile device case with a print roll access door in an open position.

FIG. 2 shows a perspective view of an example of a mobile device with a print roll access door in an open position.

FIG. 3 shows a perspective view of the mobile device of FIG. 2 received within the mobile device case of FIG. 1.

FIG. 4 shows a side view of the mobile device case of FIG. 1.

FIG. 5 shows a side view of the mobile device of FIG. 2.

FIGS. 6A-6C show perspective views of a mobile device door opening operation of the mobile device case of FIG. 1.

FIG. 7 shows a perspective view of an example of a mobile device charging system with a mobile device received within a mobile device case.

FIG. 8 shows a perspective view of an example of a mobile device charging system with a mobile device lacking a mobile device case.

FIG. 9 shows a perspective view of the mobile device charging system of FIG. 7 in a charging configuration.

FIG. 10 shows a perspective view of the mobile device charging system of FIG. 8 in a charging configuration.

### DETAILED DESCRIPTION

The systems and apparatus disclosed herein are usable to provide protection and security to mobile electronic devices. The disclosed examples may be configured for and used with any type of mobile electronic device that would benefit from a protective case, such as mobile phones, tablets, computers, cameras, navigation devices, payment devices, etc. While the disclosed examples are described herein principally with respect to mobile payment processing devices, it will be understood that the invention is not so limited.

The disclosed systems and apparatus may be adapted for use with mobile electronic devices having multiple functional or accessible portions, e.g., mobile payment processing devices with both input displays and printing functions. To this end, the disclosed examples include doors, windows, or other openings to enable access to the encased mobile electronic device, e.g. to permit charging or printing. Such devices may include a number of functional features, such as payment features, for which access is important while enclosed in a protective case, including magnetic stripe readers (MSR), Europay, MasterCard, and Visa (EMV) card readers, and near-field communication (NFC) readers, for example. The disclosed examples may thereby enable protection of electronic devices without interfering with any of the underlying functionality of the electronic devices.

The disclosed cases may be particularly suitable for mobile payment processing devices having an on-board printer, e.g. to print receipts. These disclosed protective cases may be configured to protect the device without the need for removal to perform paper changes/replacements. In one example, the disclosed examples may form a multi-part case with a dynamic hinge and one or more dynamically moving doors. The hinge axis for the door may be coaxial and aligned with the hinge axis of the printer door on the device. The hinge(s) may be mechanical (e.g. pinned) hinges or may be living hinges formed from material of the protective case. This allows the case door to move with the device door during opening (e.g. to replace printer rolls) while still providing protection to the entire device.

Additionally, the disclosed examples include mobile device protective cases and chargers that may be used in combination with one another. Conventional protective cases may not accommodate or fit on OEM charge cradles, and/or may not offer a charging system designed to accommodate the protective case. This may leave charging via USB cable as the only option, which may require additional time and/or lead to cable and/or device failures with repeated use. The disclosed examples may be configured to eliminate the need to purchase a separate charger, accessory, or modification when the mobile device is within the case. Thus, the mobile device may be used or charged whether inside or out of the protective case. In one example, a mobile payment device may include a “window” feature to allow “standoff and relief” features in the charger to support the device directly, whether the device is contained within the case or outside of the case. In other words, there is no need to remove the case or reconfigure the charger, because the case includes windows or apertures that allow the charger to directly contact and support the mobile payment device during charging. The mobile payment device case may also include other windows or apertures to allow access to features and/or buttons on the mobile payment device during use of the mobile payment device.

Additional advantages of the disclosed examples will be apparent from the description herein.

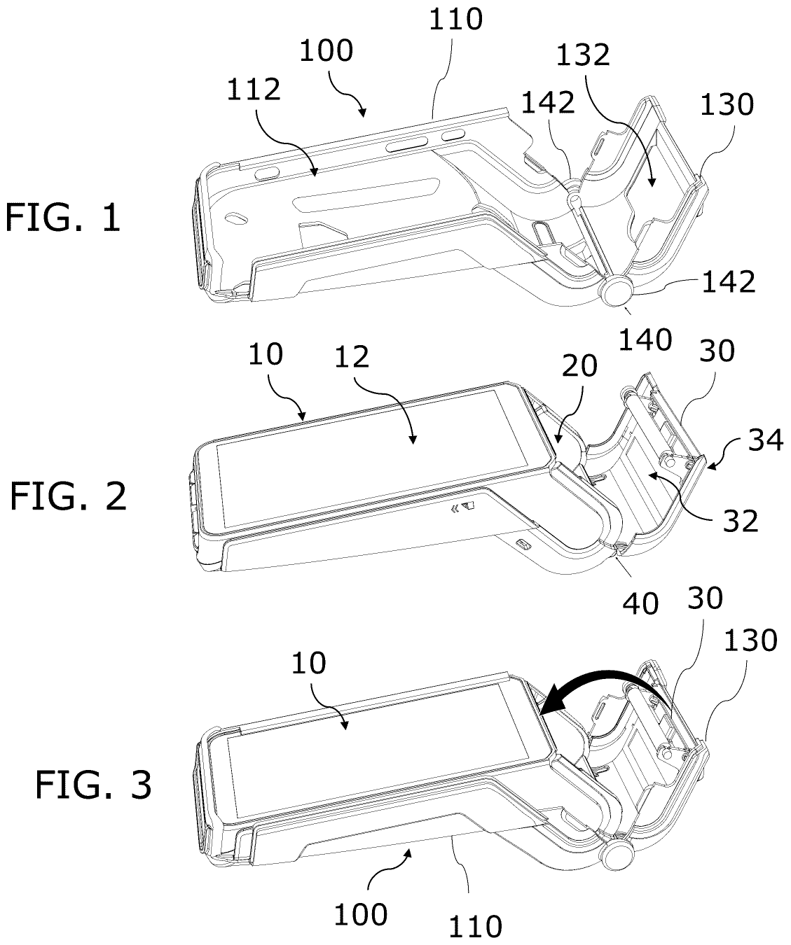

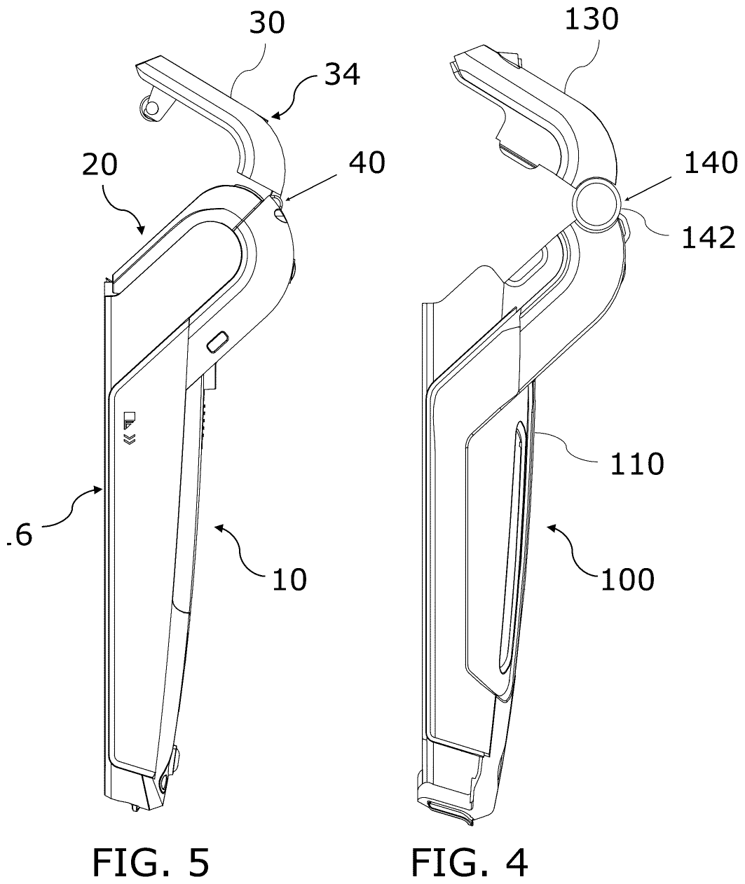

With reference to the drawings, FIG. 1 illustrates an example mobile device case 100. Mobile device case 100 is configured to at least partially encase and protect a mobile electronic device, such as mobile electronic device 10, as shown in FIGS. 2 and 3. As an example, mobile device case 100 includes a protective shell 110 and a mobile device case door 130. Additional details of this mobile device case 100 are set forth below.

Protective shell 110 is configured to surround and protect at least a portion of the mobile device 10. In some examples, protective shell 110 covers the entirety of the rear surface and side surfaces of mobile electronic device 10, and at least a portion of the front surface of mobile electronic device 10. In some examples, protective shell 110 covers all portions of the mobile electronic device 10 other than a screen 12 of the device 10, including portions of the bezel of the mobile electronic device 10. In such examples, protective shell 110 may include a window 112 to allow access to the screen 12 of mobile electronic device 10. In other examples, protective shell 110 may include an actuator that is accessible by a user when mobile electronic device 10 is received within mobile device case 100. The actuator may be movable to actuate a button on mobile electronic device 10 that is otherwise protected or shrouded by mobile device case 100.

Protective shell 110 may be formed from a material suitable for protecting and/or dissipating force from impacts to mobile device case 100. Suitable materials for protective shell 110 may include rigid polymer and/or elastomeric polymer materials. Other suitable materials will be apparent to those of ordinary skill in the art from the description herein. Protective shell 110 may be formed from a single piece of protective material(s), or may be formed from multiple connecting or interlocking pieces, as desired to encase and protect mobile electronic device 10. In one preferred example, protective shell 110 is formed from a rigid substrate (e.g., polycarbonate) overmolded with an elastomer material (e.g., thermoplastic polyurethane (TPU)).

Protective shell 110 may be configured to accommodate mobile electronic device 10 within in a manner that prevents removal of mobile electronic device 10 from mobile device case 100. In some examples, mobile device case 100 may further include a fastener or lock to prevent removal of mobile electronic device 10. For example, protective shell 110 may include one or more fasteners or locks that are actuated or engaged by corresponding elements on a charging cradle (discussed in greater detail herein), to prevent removal of mobile electronic device 10 when the device is unattended and/or charging. Suitable fasteners and/or locks will be known from the description herein.

As shown in FIG. 2, mobile electronic device 10 may comprise at least one compartment 20. Compartment 20 may be provided on mobile electronic device 10 to enhance the functionality of mobile electronic device. For example, where mobile electronic device 10 is a mobile payment processing device, compartment 20 may be configured to contain at least one receipt printer roll, e.g. for feeding paper to a printer for printing receipts. For examples including at least one compartment 20, mobile electronic device 10 may further include a mobile device door 30 pivotable on a mobile device hinge 40 to close the at least one compartment 20. With reference to the above example, where mobile electronic device 10 is a mobile payment processing device, mobile device door 30 may be sized to allow removal and replacement of a receipt printer roll held in compartment 20.

For mobile electronic devices 10 having a compartment 20 and/or a mobile device door 30, mobile device case 100 includes a mobile device case door 130. Mobile device case door 130 is coupled to protective shell 110 via a mobile device case hinge 140. Mobile device case door 130 is pivotable on the mobile device case hinge 140 between a closed position and an open position, e.g. to close or open the underlying compartment 20 in mobile electronic device 10.

Mobile device case door 130 and hinge 140 are configured to simplify and promote access to the contents of compartment 20, even when mobile electronic device 10 is accommodated within protective shell 110. Thus, mobile device case door 130 may be positioned such that the interior of compartment 20 is accessible by way of mobile device door 30 and mobile device case door 130 when mobile electronic device 10 is accommodated within protective shell 110. In this way, the contents of compartment 20 may be access or replaced without the need to remove mobile electronic device 10 from mobile device case 100. With reference to the above example, where mobile electronic device 10 is a mobile payment processing device, mobile device case door 130 may also be sized to allow removal and replacement of a receipt printer roll held in compartment 20. Mobile device door 30 and mobile device case door 130 may further include respective windows 32 and 132 to enable viewing contents of compartment 20 without the need to open doors 30 and 130.

In a preferred example, as shown in FIG. 3, mobile device case hinge 140 is positioned to be coaxial with mobile device hinge 40 when mobile device 10 is accommodated within protective shell 110. Making hinges 40 and 140 coaxial may desirably simplify opening and closing of mobile device case door 130 and mobile device door 30, e.g., by allowing them to be simultaneously pivoted together between closed and open positions, as shown diagrammatically by arrow in FIG. 3.

In one example, to promote forming hinges 40 and 140 coaxially, mobile device case hinge 140 may be formed by a pair of coaxially aligned hinge pins 142. Hinge pins 142 are positioned at both ends of the mobile device hinge 40 when mobile electronic device 10 is accommodated with protective shell 110, along the axis defined by mobile device hinge 40.

Mobile device case door 130 may be held in a closed position by a friction fit, detent, latch, or other structure. In some examples, mobile device case door 130 may be openable by application of sufficient pressure to mobile device case door 130 in an opening direction. In other examples, mobile device case 100 may include an actuator to be pressed or manipulated in order to open mobile device case door 130.

Similarly, mobile device door 30 may be held in a closed position by a friction fit, detent, latch, or other structure. Additionally, mobile device door 30 may be retained in the closed position when mobile electronic device 10 is accommodated within mobile device case 100, e.g. by mobile device case door 130. In some examples, mobile device door 30 may be openable by application of sufficient pressure to mobile device door 30 in an opening direction. In other examples, mobile electronic device 10 may include an actuator 34 to be pressed or manipulated in order to open mobile device door 30. Where mobile electronic device 10 includes an actuator 34 for opening mobile device door 30, protective shell 110 of mobile device case 100 may be structured to ensure that actuator 34 is accessible or actuatable when mobile electronic device 10 is accommodated within mobile device case 100.

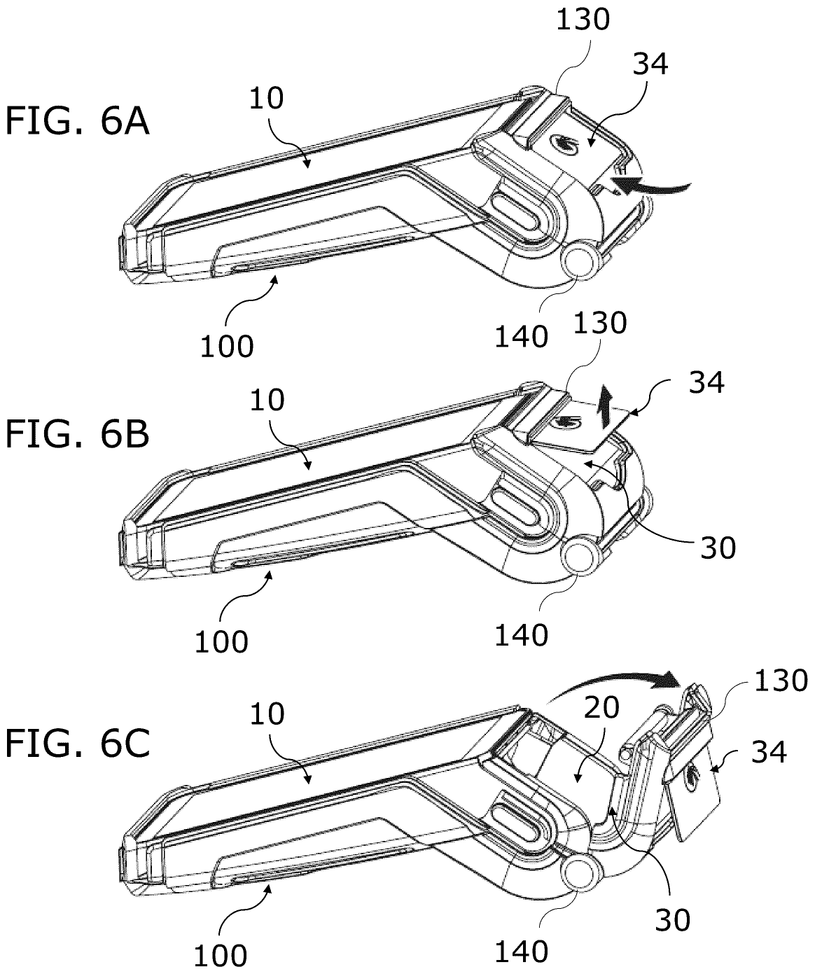

In one example, protective shell 110 may include a window or access port in the location of actuator 34, to enable actuation of actuator 34 to open mobile device door 30 when mobile electronic device 10 is accommodated within mobile device case 100. As shown in FIGS. 6A-6C, mobile device case door 130 includes a window providing access to and space to manipulate actuator 34. In this example, to open mobile device door 30, a user may actuate actuator 34 through the opening in protective shell 110, without the need to remove protective shell 110, as shown in FIG. 6B. By pulling outward on actuator 34, as shown in FIGS. 6B and 6C, mobile device door 30 and mobile device case door 130 may open together along hinges 40 and 140, as described herein.

Protective shell 110 may further include a latch or actuator to be actuated prior to or simultaneous with actuation of actuator 34, to enable joint movement of mobile device door 30 and mobile device case door 130.

In a preferred example, when mobile device door 30 and mobile device case door 130 are in the closed positions, opening mobile device door 30 with actuator 34 causes outward movement of mobile device door 30, which in turn results in contact between mobile device door 30 and mobile device case door 130, causing movement of mobile device case door 130 from the closed position toward the open position. In other words, actuating actuator 34 may cause simultaneous, joint opening of both mobile device door 30 and mobile device case door 130. Likewise, when both mobile device door 30 and mobile device case door 130 are in the open positions, closing mobile device case door 130 may simultaneous cause closing of mobile device door 30, particularly where both doors have coaxial hinges and are configured to rotate together around a common axis.

As one example for implementing such operation, protective shell 110 may include at least one detent configured to retain mobile device case door 130 in the closed position. In this example opening mobile device door 30 with actuator 34 can be configured to force mobile device door 30 and mobile device case door 130 outward, such that mobile device case door 130 disengages from the detent to move toward the open position.

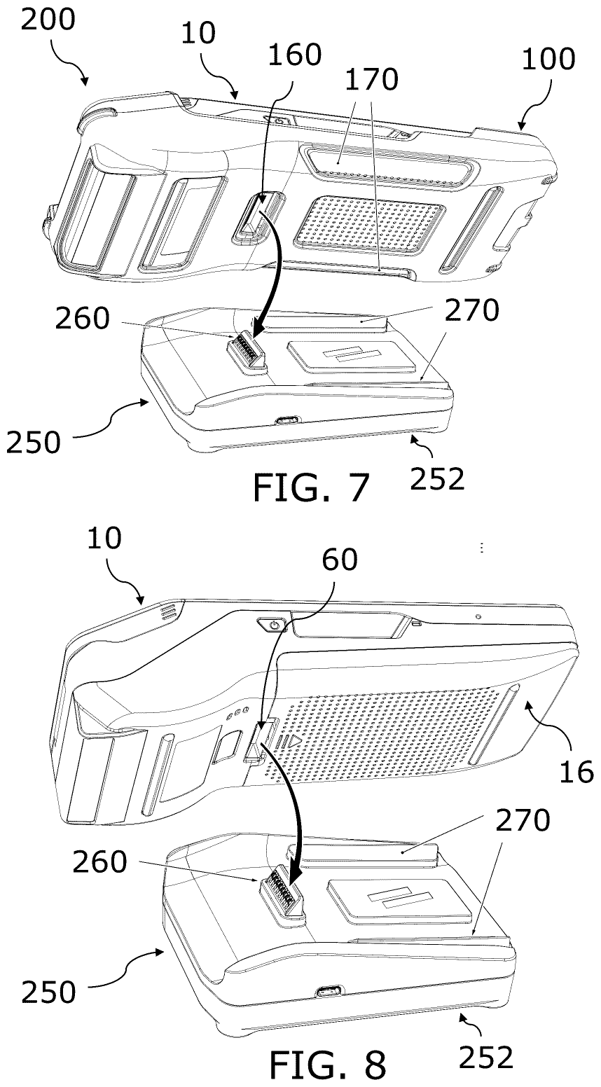

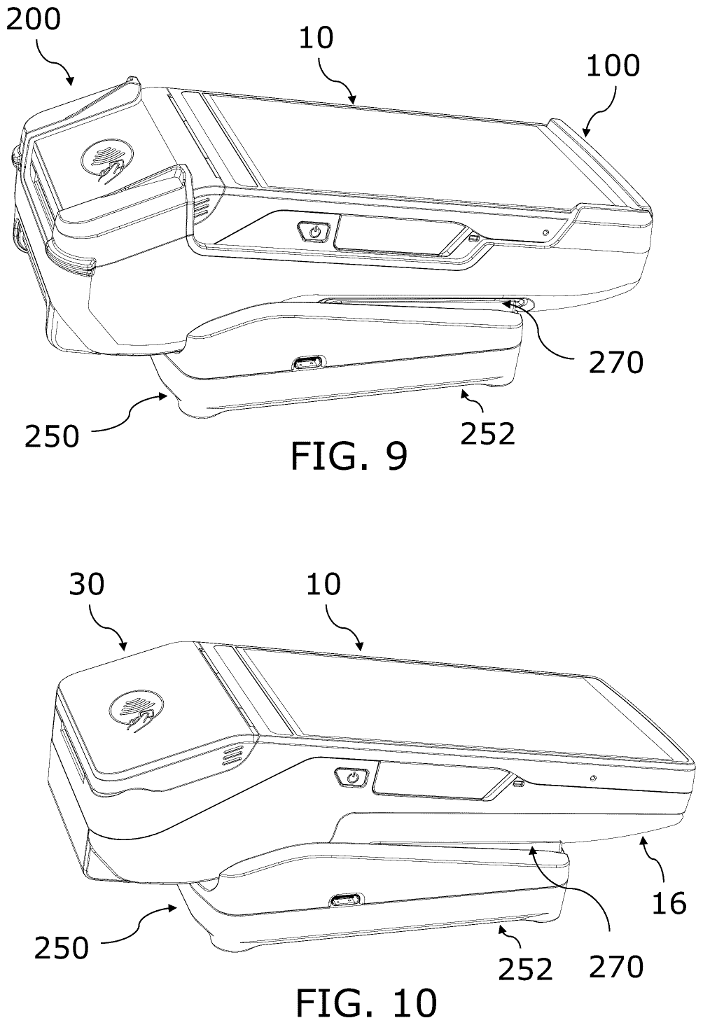

FIGS. 7-10 illustrate an example mobile device charging system 200. Mobile device charging system 200 is configured to allow for electrical charging of a mobile electronic device, such as mobile electronic device 10, regardless of whether the mobile electronic device is received within a mobile device case, such as mobile device case 100. As an example, mobile device charging system 200 includes mobile electronic device 10, mobile device case 100, and mobile device charging cradle 250. Additional details of this mobile device charging system 200 are set forth below.

As set forth above, and as shown in FIG. 7, mobile device case 100 has a protective shell 110 configured to surround and protect at least a portion of a mobile electronic device 10. It will be understood from the description herein that mobile device charging system 200 is not limited to use with mobile electronic device 10 or mobile device case 100, but is usable with many different configurations of mobile electronic device and case, consistent with the description below.

Mobile device charging cradle 250 is configured to electrically interface with electrical contacts of a mobile electronic device, and thereby provide electrical power or charging thereto. In some examples, as shown in FIGS. 7-10, mobile device charging cradle 250 may have a base 252 configured to be positioned on a surface. In other examples, mobile device charging cradle 250 may be fixedly or movable coupled to one or more structures for securably positioning or repositioning cradle 250.

Mobile device charging cradle 250 has a cradle charging interface 260, which may include one or more electrical contacts. Cradle charging interface 260 is not limited to any particular form or number of electrical contacts. The design of cradle charging interface 260 may be dictated by the design of the corresponding device charging interface 60 provided on mobile electronic device 10. Mobile device charging cradle 250 may further include electrical wiring in communication with cradle charging interface 260. In an example, electrical wiring extends at least partially within or through device charging cradle 250, and may extend out through cradle 250 or base 252, to electrically connect with a further electronic device and/or power source.

In some examples, as shown in FIGS. 7 and 8, mobile electronic device 10 includes a device charging interface 60 provided on a first (e.g. rear) surface 16 thereof. Device charging interface 60 is designed to interface directly and mate with cradle charging interface 260 when mobile electronic device 10 is not received within any mobile device case, as shown in FIG. 8. Likewise, mobile electronic device 10 may be designed to be physically supported by mobile device charging cradle 250 when mobile electronic device 10 is not received within any mobile device case. Nonetheless, according to the features of mobile device charging system 200, mobile device charging cradle 250 can physically support and/or electrically interconnect with mobile electronic device 10 when mobile electronic device 10 is received within mobile device case 100, as shown in FIG. 7.

In one such example shown in FIG. 7, protective shell 110 includes one or more apertures 170 on a portion of protective shell 110 covering the first surface 16 of mobile electronic device 10, e.g. a rear portion of protective shell 110. Apertures 170 provide an opening extending from an exterior surface of protective shell 110 to mobile electronic device 10. Apertures 170 are preferably sized to enable direct contact with and support of first surface 16 of mobile electronic device 10 while avoiding or minimizing loss of protection to mobile electronic device 10 provided by mobile device case 100.

Mobile device charging cradle 250 includes one or more projections 270 positioned to correspond to apertures 170. Projections 270 are configured to directly contact and support first surface 16 of mobile electronic device 10 when device charging interface 60 is electrically coupled to cradle charging interface 260. Preferably, projections 270 contact and support mobile electronic device 10 regardless of whether mobile electronic device 10 is received in mobile device case 100. In other words, projections 270 directly contact and support first surface 16 of mobile electronic device even when mobile electronic device 10 contained in mobile device case 100 and placed on mobile device charging cradle 250. In this manner, it is unnecessary to remove mobile electronic device 10 from mobile device case 100 to charge mobile electronic device 10 on mobile device charging cradle 250.

As shown in the example of FIGS. 7 and 8, apertures 170 can be formed as a pair of elongated openings or windows positioned on either side of device charging interface 60. Correspondingly, projections 270 can be formed as a pair of elongated upstands or ledges positioned on either side of cradle charging interface 260 in positions corresponding to the pair of apertures 170. Apertures 170 extend along respective long sides of mobile device case 100 to enable projections 270 to provide stable support for mobile electronic device 10.

In some examples, mobile electronic device 10 received within mobile device case 100 is supported only by the contact with projections 270 when mobile electronic device 10 is seated and charging on cradle 250. Put another way, cradle 250 can be configured not to support mobile electronic device 10 through contact with mobile device case 100. Moreover, cradle 250 can be configured not to support or contact mobile device case 100 at all. In such examples, it can be ensured that cradle 250 provides stable support to mobile electronic device 10 even when the device is not received in mobile device case 100.

In addition to apertures 170, mobile device case 100 may further include at least one charging opening 160. Charging opening 160 is positioned at a location corresponding to device charging interface 60 when mobile electronic device 10 is received within mobile device case 100. When mobile electronic device 10 received within mobile device case 100 is placed on mobile device charging cradle 250, device charging interface 60 interconnects with cradle charging interface 260 via charging opening 160 in case 100, thereby enabling electrical charging of mobile electronic device 10 without the need for removal of mobile device case 100.

Although the invention is illustrated and described herein with reference to specific embodiments, the invention is not intended to be limited to the details shown. Rather, various modifications may be made in the details within the scope and range of equivalents of the claims and without departing from the invention.

1. A mobile device case, the mobile device comprising at least one compartment closed by a mobile device door pivotable on a mobile device hinge, the mobile device case comprising:
a protective shell configured to surround and protect at least a portion of the mobile device; and
a mobile device case door coupled to the protective shell via a mobile device case hinge, the mobile device case door pivotable on the mobile device case hinge between a closed position and an open position,
wherein when the mobile device is accommodated within the protective shell, the at least one compartment is accessible by way of the mobile device door and the mobile device case door.

2. The mobile device case of claim 1, wherein when the mobile device is accommodated within the protective shell, the mobile device case hinge is coaxial with the mobile device hinge.

3. The mobile device case of claim 1, wherein the mobile device case hinge comprises a pair of hinge pins coaxially aligned at each end of the mobile device hinge.

4. The mobile device case of claim 1, wherein the mobile device includes an actuator for opening the mobile device door, and wherein when the mobile device is accommodated within the protective shell, the actuator is accessible to open the mobile device door.

5. The mobile device case of claim 4, wherein when the mobile device case door is in the closed position, opening the mobile device door with the actuator causes movement of the mobile device case door from the closed position toward the open position.

6. The mobile device case of claim 5, wherein the protective shell comprises at least one detent configured to retain the mobile device case door in the closed position, and opening the mobile device door with the actuator causes the mobile device case door to disengage from the at least one detent to move toward the open position.

7. The mobile device case of claim 4, wherein when the mobile device case door is in the open position, closing the mobile device case door also causes closing of the mobile device door.

8. The mobile device case of claim 4, wherein the mobile device case includes an access port for enabling access to the actuator to open mobile device door.

9. The mobile device case of claim 1, wherein the mobile device door and the mobile device case door comprise respective windows to enable viewing contents of the at least one compartment.

10. The mobile device case of claim 1, wherein the mobile device is a mobile payment processing device, the at least one compartment is configured to contain at least one receipt printer roll, and the mobile device door and the mobile device case door are sized to allow removal and replacement of the receipt printer roll.

11. The mobile device case of claim 1, wherein the protective shell comprises a rigid substrate overmolded with an elastomer.

12. A mobile device charging system comprising:
a mobile device case comprising a protective shell configured to surround and protect at least a portion of a mobile device; and
a mobile device charging cradle having a cradle charging interface, wherein
the mobile device includes a device charging interface on a first surface thereof,
the protective shell includes one or more apertures on a portion of the protective shell covering the first surface,
the mobile device charging cradle includes one or more projections positioned to correspond to the one or more apertures, and
the one or more projections directly contact the first surface of the mobile device through the one or more apertures when the mobile device is in the mobile device case and the device charging interface is coupled to the cradle charging interface.

13. The mobile device charging system of claim 12, wherein the mobile device case includes a charging opening at a location corresponding to the device charging interface.

14. The mobile device charging system of claim 12, wherein the one or more apertures comprise a pair of elongated apertures positioned on each side of the device charging interface; and the one or more projections comprise a pair of elongated projections positioned to correspond to the pair of elongated apertures.

15. The mobile device charging system of claim 14, wherein mobile device is supported by only the pair of elongated projections and the cradle charging interface when the mobile device is in the mobile device case and the device charging interface is coupled to the cradle charging interface.

16. The mobile device charging system of claim 15, wherein the mobile device charging cradle does not support the mobile device case when the mobile device is in the mobile device case and the device charging interface is coupled to the cradle charging interface.

17. The mobile device charging system of claim 16, wherein the mobile device charging cradle does not contact the mobile device case when the mobile device is in the mobile device case and the device charging interface is coupled to the cradle charging interface.

18. The mobile device charging system of claim 12, wherein the protective shell comprises a rigid substrate overmolded with an elastomer.
